(19) United States
(12) Patent Application Publication
(10) Pub. No.: US 2008/0270245 A1
(43) Pub. Date: Oct. 30, 2008

(54) System For Processing Stored Value Instrument

(75) Inventors: Salah E. Boukadoum, Dallas, TX (US); Steven K. Frazee, Dallas, TX (US)

Correspondence Address: BARNES & THORNBURG LLP, P.O. BOX 2786, CHICAGO, IL, 60690-2786, US

(73) Assignee: ALLIANCE DATA SYSTEMS CORPORATION, Dallas, TX (US)

(21) Appl. No.: 10/598,778

(22) PCT Filed: Mar. 10, 2005
(86) PCT No.: PCT/US2005/007838

§ 371 Date: Sep. 28, 2007

Related U.S. Application Data
(60) Provisional application No. 60/552,309, filed on Mar. 11, 2004.

(51) Int. Cl. G06Q 20/00

(52) U.S. Cl. 705/17; 235/379; 705/41; 705/35

(57) ABSTRACT

Disclosed is a method for managing at least one transaction through traditional credit card authorization payment infrastructures by supplying personal account numbers to retailers. Personal account numbers correspond to issuer managed accounts that may be assigned at point of sale, and activated at redemption, and may restrict which merchants can process the personal account number to extract value therefrom. Also disclosed is an apparatus for distribution in retail and redemption at selected redemption sites. The apparatus is a card that includes machine readable code and account information where at least some of data corresponding to the machine readable code differs from the account information. The card may configured to retain a personal account number or other account information compatible with selected redemption site interfaces. Redemption can be limited to selected retailers or groups of retailers.

### BACKGROUND

Product and service providers (“Providers”) are interested in new ways to allow purchasers to pay for goods and services offered by such Providers. These methods may include offering electronic payments techniques that are different than known credit card, debit card, or cash payment techniques. Providers also wish to be able to simply and efficiency track collections by distributors of the Provider's goods and services.

Providers are desirous of a payment vehicle for Consumers who can not purchase goods and services using traditional credit/debit products or do not have a bank account. This demographic is often called the “unbanked” or “underbanked.” An example of unbanked consumers are those who can not subscribe for monthly-billed long distance services who must instead purchase prepaid long distance phone cards. In addition to servicing Consumers on the basis of convenience and cost competitor, these cards may service a demographic that exchanges cash for services. Non-unbanked consumers with credit and debit payment options can purchase phone cards on the Internet or through an IVR (Interactive Voice Response) system. Payment is made with a credit card. However, consumers without credit cards must exchange cash for such products. The market has developed so that the exchange of cash for service occurs in traditional retail locations because the Retailer is accustomed to handling cash. Products that are distributed in this manner are often called “prepaid products”.

Collecting payments related to delivery of prepaid products through the supply chain up to now may have been problematic because the prepaid products must be passed through various distributors. The result is the reconciliation or “settlement” of collections between the original Providers and its various distributors has been laborious. Settlement may be further complicated by the fact that payments made through electronic payment entities, such as banks and credit card companies, requires additional instances of money movement that must be tracked. Providers need a method that leverages existing credit/debit card settlement systems so that the Provider can benefit from receiving all funds from the sale of the Provider's products and services from a single trusted entity. With such a method, the Provider would see savings in collections, bad debts, and costs related to billing and risk management.

Current methods exist that allow Consumers to purchase prepaid service cards and activate such cards using a pin. A common example is a prepaid phone card that is purchased by a Consumer to add minutes to their cell phone service. A Consumer purchases a card, calls a phone number shown thereon, and in response to instructions provided by an interactive voice response system, enters a pin number shown on the card to receive the purchased minutes. Such systems require the phone company in this example to create and maintain a separate PIN system. Further, the value assigned to the that PIN is valid only for one purpose, to move the minutes on that particular card to the user's cell phone account.

Providers may also wish offer to a stored-value product that can be distributed and activated in retail using the Retailer's exiting activation system, but then only be redeemed at selected redemption sites. Such redemption sites may be, for example, on-line web sites or other e-commerce sites. The Provider may also wish to only allow redemption using interfaces that are not common credit card swipe interfaces such as interactive voice response systems and web-based transaction systems. This limitation may be desirable because of risks associated with such common credit card interface processes. Two of these risks are caused by incomplete or short-cut authorization schemes used in partial authorization or pre-authorization systems. Partial or pre-authorization occurs, for example, when credit cards are used at gas pumps. The gas pump may permit a consumer to begin fueling even before the Issuer actually authorizes the transaction so long as the card fits industry standard credit card formats.

The industry permits such use for a number of reasons, including expediency (Consumers will not wait for a card to be authorized by an issuing bank to get gas), and risk management (the total dollars at stake in a gas purchase are relatively low). However, such use, especially if fraudulent, may effectively be devastating to a Provider's value card program.

Briefly and in accordance to the foregoing, disclosed is a system and method that allows a Provider to enters into a relationship with a financial value provider such as a credit card company (an “Issuer”) and to issue personal account numbers (“PANs”) for use by Providers to provide to Consumers for purchase of the Provider's goods and services. The use of PANs to identify a stored-value or other payment option assigned to the consumer enables the Provider to accept payment or redemption for service through existing credit card processing interfaces and infrastructure. For example, if an Issuer's PANs are provided to a consumer, then the consumer can enter the PAN along with other data typically associated with an Issuer account number such as expiration date through standard technology via a web site, customer service, IVR or other mechanism. For example, if a web services company wished to issue a stored-value product sold in retail, then the purchaser of that product could redeem it on the web using the same basic tools used to accept a credit card for payment. The Provider may choose to create a special web page and prompts for the redemption of the product, but the underlying processing of the PAN inclusive of authorization and settlement will be the same. An additional benefit is reducing the number of interfaces required by the Provider.

The present system and method provide functionality such that the Provider no longer needs to create a proprietary stored value system. Using this method, the need to generate and distribute value-stored PINs is removed. Given that the Provider no longer must host a database of PINs, the need for POSA (Point of Sale Activation) companies, who are often needed to complete PIN authentications or activations is removed.

Also disclosed is an apparatus, system, and method for allowing a Provider to provide its value cards through Retailers which can be activated using the Retailer's existing systems, for redemption at specified redemption sites. The card may be configured to include payment account in non-industry standard form to avoid pre-authorization and partial authorization problems, or to limit use to web-based transactions. The card may also include a machine readable information including codes, barcodes, radio frequency identification (RFID), carrier cards, magnetic stripes, magnetic cards, or other type of machine readable codes, indicia, numbers, characters, symbols, pictures or images, mechanisms, signals, structures, sounds, impulses, transmissions, devices or chips, corresponding to the Retailer's activation system to allow point of sale activation. Accordingly, disclosed is a system and method that combine the card described above, the Retailer's point of sale activation system, and the redemption site's payment acceptance systems for use in activating, loading, and redeeming the value on the card.

### BRIEF DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

FIG. 1 is a simplified diagram showing entities that participate in a method for prepaid delivery, sales, redemption, and settlement using traditional credit/debit card issuing systems;

FIG. 2 is a simplified flowchart showing distribution steps in the method of FIG. 1;

FIG. 3 is a simplified flowchart showing redemption steps in the method of FIG. 1;

FIG. 4 is a simplified flowchart showing settlement steps in the method of FIG. 1; and

FIG. 5 is a simplified flowchart showing one example of the method of FIG. 1.

FIG. 6 is a simplified view of the front and back sides of a card that can be distributed in retail, activated by a retailer's existing POSA system, and redeemed at authorized redemption sites; and

FIG. 7 shows a system that includes the card of FIG. 6 in association with an Issuer's and the Retailer's POSA system.

### DETAILED DESCRIPTION

While this disclosure has been described as having exemplary embodiments, this application is intended to cover any variations, uses, or adaptations using the general principles set forth herein. It is envisioned that those skilled in the art may devise various modifications and equivalents without departing from the spirit and scope of the disclosure as recited in the features, elements, steps, or combinations thereof. Further, this application is intended to cover such departures from the present disclosure as come within the known or customary practice within the art to which it pertains.

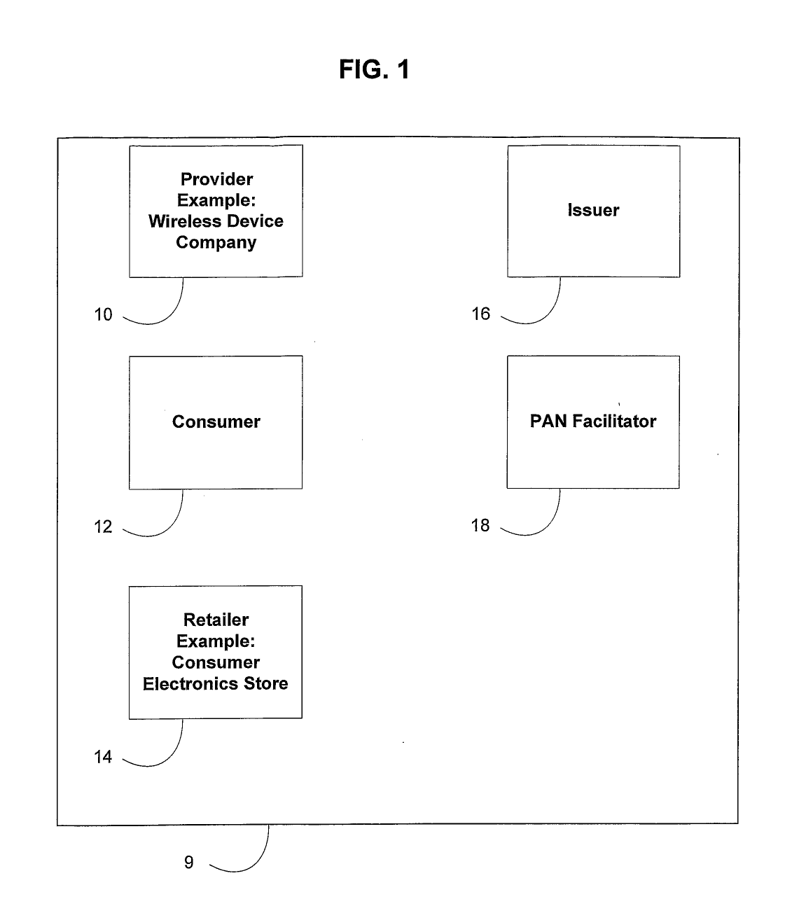

For purposes of this disclosure, the following entities 9, shown in FIG. 1., are defined as follows.

“Issuer” 16: The Issuer 16 of the PAN (Personal Account Number). Issuer 16 may correspond to, but not be limited to, any bank, credit card company, or other financial institution in the business of providing electronic credit services to others. The Issuer 16 may interact with other third party vendors such as prepaid processing companies or billing and statement companies. Issuers may manage accounts for consumers, including debit, credit, point-based, or other incentive equivalent-based accounts. For purposes of this disclosure, the term Issuer includes the actual Issuer 16 and vendors who provide such related services.

“Provider” 10: The Provider 10 is the product/service company that is offering its goods and/or services to the Consumer 12.

“PAN Facilitator” 18: The PAN Facilitator 18 acts as the single technology supplier that enables the supply chain to deliver stored-value and other products using this method, for sale to consumers. In the descriptions of this method, the PAN Facilitator 18 is shown to service the Retailer 14 (described below) directly. This need not be the case. A variety of distribution partners can participate in both the delivery of the physical product to retail for merchandising and sales and for the delivery and acquisition of data. For simplicity, the term PAN Facilitator 18 is intended to generally include all such partners acting in concert.

“Retailer” 14: The Retailer 14 or merchant represents the point of purchase where the consumer (described below) of the product exchanges value (typically money or credit) in return for receiving the product or service. A Retailer 14 can be, but is not limited to, a “brick and mortar” location, a web site, a bank, or personal interaction between a salesperson and a Consumer.

“Consumer” 12: The Consumer 12 is the entity that acquirers the product (hereafter “product” includes products or services) for redemption. Any business or person can be a Consumer 12.

I. Personal Account Number Method

The present method includes the following steps.

### Step 1—PANS Delivered to PAN Facilitator

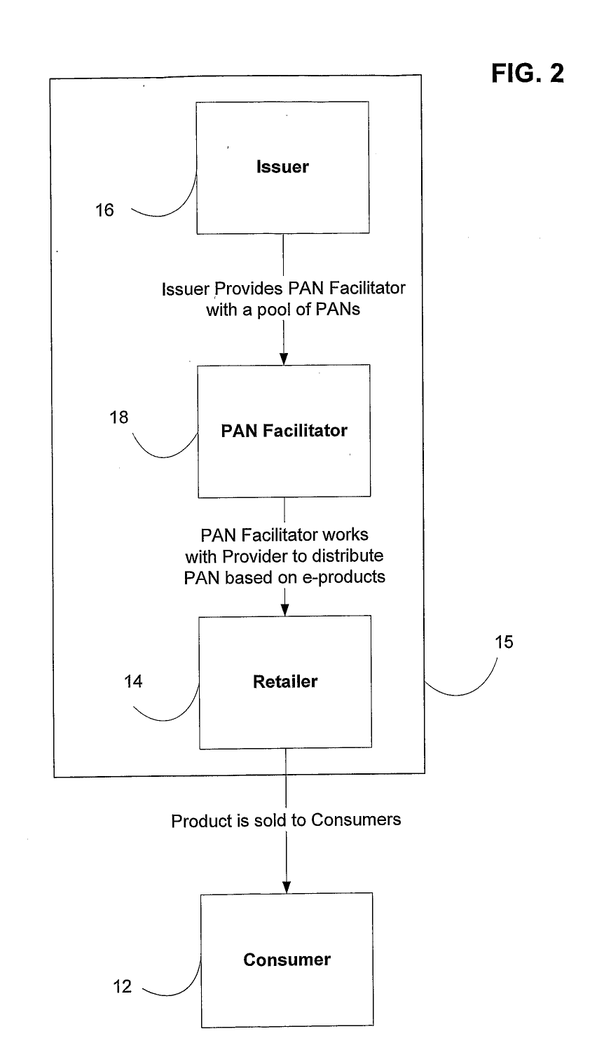

FIG. 2 shows the general distribution of PANs as described in steps 1-3. A personal account number facilitation system 15 generally includes the entities or their respective information infrastructures and described below.

In the present method, PANs and associated data such as expiration dates that have typically been used to identify a credit or debit card product are used to provide a stored-value like payment and redemption model. Thus, an Issuer 16, who has experience with credit card technologies, is generally a capable of providing PANs. A benefit of the Issuer's participation is that the Issuer 16 has existing business relationships, systems and business processes to account for, track and settle accounts using PANs as identifiers.

### Step 2—PAN Facilitator Assigns PANS to Products

PANs and other associated data can be assigned to a product or stored value instrument in a number of ways. Once such case would be the process wherein the PAN Facilitator 18 assigns the PANs to a particular Provider 10 so that the PANs can be printed on to a plastic card. For example, the PAN Facilitator 18 could work with a phone card supplier to create $20 cards that are sold in retail. This assignment includes assigning both a Provider 10 and a value to a given card product. The value can be dollars or units or any other accounting mechanism. For purposes of this disclosure, value shall be expressed as dollars. For example: PAN No.: 6011998021027033 is assigned to a wireless services provider by the PAN Facilitator 18 and given the static value of $20, or other predetermined value.

The process of assigning the $20 value or the Provider 10 to the PAN can happen a number of ways. In one embodiment, the value is assigned prior to distribution. In another embodiment, the value is assigned at the point of sale. In the point of sale embodiment, additional data collection may be required for authentication purposes. In accordance with the present example, the PAN Facilitator 18 communicates back to the Issuer 16 and identifies that the PAN in question has now been assigned to the wireless phone service provider and given a value of $20.

Assignment of a PAN to a value and Provider 10 during redemption may include further steps to prevent fraud by validating the redemption is occurring by the Provider 10 that was assigned the PAN and for the value that was associated with it, or a lesser value if the PAN can be used multiple times.

To allow the PAN to be carried by Consumers 12, the PAN may be stored in numerous ways including having data related to the PAN sent to a card printer so this data can be printed onto the card. The data may be visible or hidden as part of the product packaging depending on the specific products marketing requirements.

A tracking number may also be assigned to the card product. This number may be separate from the PAN and other data but can act as an identifier to the product as well. In one implementation, the tracking number is coded onto the magnetic stripe of the plastic card. The format for this encoding can vary from application to application but is often designed to be compatible with existing Point of Sale Activation (“POSA”) technology for an existing retailer. In another embodiment, the PAN and other data may be encoded on the magnetic stripe of the card in an industry standard format, such as the ABA format, so that the card can be used for redemption at traditional POS machines that require a credit card swipe. The magnetic stripe is used to identify the card product so that it can be activated when sold in retail. The creation of card products, distribution of the physical product and merchandising in retail may use any supply chain mechanism for prepaid products known in the art.

Some retailers have equipment that does not support the activation of a plastic card, but instead uses a method of PIN printing. In one embodiment of the present method, PANs and other important data can be distributed in the same manner as a PIN, meaning it can be delivered to a receipt, thermal card, email or other manner to put the PAN along with other data and instructions in the hands of the Consumer 12.

Step 3—Consumers Purchases/Receives Product

The Consumer 12 purchases the product in retail as they would any other product. Typically there is a “retail value” associated with the product. The retail value is usually the price for which the product is sold as well as the value that it will be redeemed. In the current example, the retail price is $20. However, Retailers can run specials selling the product for less than the retail price or the value can have a retail price but a non-dollar value (as in a subscription or unit based product).

In a typical distribution chain, the Provider 10 will sell products through one or more distributors who will sell to one or more Retailers. Ownership of the Products may change as the Products move from Provider 10 to distributor to Retailer 14, with payments being made for the product at each move. Another commonly seen distribution model does not involve any money being transferred between the Provider 10 and its distributor or its Retailer 14. Instead, the Provider 10 is paid upon sale of the Product to a Consumer 12 by a Retailer 14. Retailers make a “margin” on the sale of the product, meaning the Retailers 14 keep the difference between the wholesale value and the retail value. In the ongoing example, if the Retailer's margin was 20%, the Retailer 14 would expect to keep $4 and remit the remaining $16 back to the Provider 10. POSA products like those discussed here are often times sold under such a consignment model. Thus, the wholesale cost of the product is not flagged as receivable from the Retailer 14 until it is sold. This model is known in the industry as zero inventory product.

Step 4—Point of Sale Activation (“POSA”)

In certain embodiments, the products must be activated upon sale. Continuing the above example, the $20 wireless card was merchandised as a plastic card with a magnetic stripe in retail and must be “turned on” once it is sold. This is POSA. The purpose of POSA is to reduce shrinkage (theft) in retail and to enable the products to be sold through the supply channel in a consignment manner.

POSA generally involves communicating data from the retail POS (point of sale) device to a backend server in real-time so that when the Consumer 12 leaves the store, the Consumer 12 has an active and working product.

In its simplest form, POSA simply activates a card. The present method is also suitable for use with more complex interfaces that enable additional data to be collected. Information may also be transmitted back to the PAN Facilitator 18 at this stage. The transaction that is sent from the Retailer 14 to the PAN Facilitator 18 could include a variety of data including but not limited to (1) Retailer ID; (2) Time and Date; (3) PAN; (4) Expiration date; (5) Other PAN associated data; (6) Product ID; (7) Tracking number (8) SKU identifier (or UPC); and/or (9) Product value (if product value is dynamic and assigned at the POS).

The Retailer ID is important as it indicates to the system what Retailer 14 has sold a product and collected funds so that the wholesale amount can be collected from the Retailer 14 by supply chain or directly by the Provider 10. The steps for collection are described in more detail below.

In a highly dynamic POS implementation, the data collected at the POS, and transmitted back to the PAN Facilitator 18, is used to assign the PAN to a given Provider 10 and to set the product value. This will typically occur in an environment where the product information is printed or delivered to the Consumer 12 at the time of sale such as where the PAN or a corresponding PAN value is printed as a PIN. For example, a PAN can be stored in the terminal or delivered to the terminal or other POS device so at the time of sale it is assigned to a specific product type and value.

In this scenario, the order of events would be as follows. First, the Consumer 12 identifies the product to be purchased, such as a $100 phone card. Next, the Retailer 14 and/or Customer interact with a user interface to produce a representation of the product, such as in the form of a printed receipt. The POS then communicates the product purchased to the PAN Facilitator 18 that then assigns a PAN to the product, for example, 6011998021027033, to the $100 phone card. This data is then communicated to the Issuer 16 so that the product can be immediately redeemed by the Consumer 12.

The sale of the product represented by the PAN is logged and the Retailer 14 that sold the product now owes the Provider 10, in this example the phone card provider, the wholesale value of the $100 product. This dynamic assignment of the PAN to a Provider 10 and value lends itself to a more efficient PAN management and assignment algorithm.

The response from the PAN Facilitator's POSA interface to the POS in response to a POSA transaction can be seen as either an “approval” or “denial” or some other identifiers having similar meaning. An approval indicates that the PAN can, should, and has been “activated” for a given product and that the Consumer 12 can now leave the store with the product. A denial can be generated for several reasons including communication failure, the PAN being already used, the PAN not existing, a tracking number not being recognized, or an inability to assign a PAN to a particular product.

Approval of the PAN causes one or more of the following actions: (1) activates or dispenses a product; (2) indicates which Retailer 14 is selling the product; (3) assigns a PAN to a product or activates a PAN; (4) assigns a value to a PAN, (some PANs may have pre-assigned values); (5) identifies that a receivable is due from the identified Retailer 14 (or the supply chain serving it); and/or (6) instructs the Issuer 16 that the product is “live” and can now be redeemed within certain parameters.

Step 5—Message to be Sent to the Issuer.

Redemption of the product may take place using existing credit/debit authorization and settlement infrastructure. For this to work properly, the PAN Facilitator 18 communicates to the Issuer 16 that the product has been activated and provides the necessary data so that the PAN can only be used for redemption through specific Provider 10 interfaces and for specific amounts. Managing where the product can be redeemed can be handled by communicating to the Issuer 16 the credit card processing Merchant ID for the activated product. The PAN Facilitator 18 can host a table of these Merchant IDs and communicate them to the Issuer 16. Other information including the value of the product, expiration date or other important data can be communicated to the Issuer 16 if required. The method may also include having a single PAN that can be used for redemption at multiple merchant sites or with multiple Retailers.

The present method works in cases where a single PAN and its associated value is allowed to be used only once, such as in a single $20 redemption or with products that allow multiple redemptions that “buy down” against the assigned value of the PAN.

Data sent to the Issuer 16 can be sent in real-time or in “batch”. Various implementations in the market that might require a large number of products to be activated at one time may use a batch method as opposed to single transactions sent to the Issuer 16.

Much like the POSA transaction, the PAN Facilitator 18 may expect a confirmation message to be received from the Issuer 16 to indicate the product has been “Activated” and can be redeemed.

In this manner, the Issuer 16, PAN Facilitator 18, and Retailer 14 work together to activate a product. This can all be done in real-time by data routing during the purchase of the product. The steps for activating may vary, but one example of such is the following: (1) Retailer 14 sends a POSA request to the PAN Facilitator 18; (2) PAN Facilitator 18 validates data and sends a PAN activate message to the Issuer 16; (3) Issuer 16 validates data and sets PAN ready for redemption; (4) Issuer 16 communicates a confirmations message to PAN Facilitator 18; (5) PAN Facilitator 18 communicates a confirmation message to the Retailer 14; and (6) The Retailer 14 provides the product the Consumer 12.

Step 6—Consumer Redeems Product.

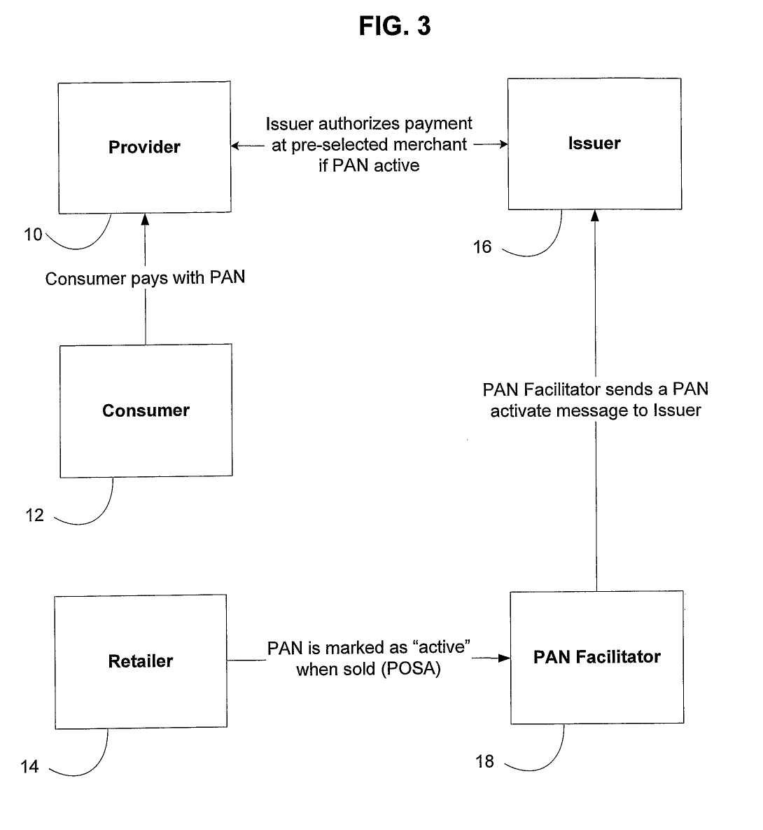

Products are redeemed as generally shown in FIG. 3. A Consumer 12 may redeem the product for goods and/or service using industry standard user interfaces such as IVR, web sites, interaction with a kiosk, or customer service. The following are some examples of PAN based products.

1. One Merchant, One Redemption ($20 Card) Example.

The Consumer 12 calls a wireless service provider's IVR and enters their mobile phone number. Then enters their PAN and any other data. The system authorizes the payment and $20 is assigned to their account. The PAN can not be used again once redeemed.

2. Multiple Merchants, One Redemption (Music Money, $19.95) Example.

Music Money (a hypothetical product) can be used to download songs from any number of music web sites. Multiple web merchants are identified as acceptable merchants for the redemption of the value. The product is redeemed for its whole value at, for example, any one web site. The value is transferred to the account for the Consumer 12 on that web site. The PAN can not be used again once redeemed.

3. One Merchant, Multiple Redemptions (MCI LD, $50) Example.

The product represents $50 of value to be used when placing a call via MCI's long distance service. The cost of each call is tallied and redeemed against the existing balance on the PAN which starts at $50. The balance is decremented as required. This is a stored-value-like paradigm. The PAN is active until the balance is spent or other factors occur that set the PAN inactive. Other factors may include expiration of a value, termination of an account for any reason, and other factors.

4. Multiple Merchants, Multiple Redemptions (Universal LD, $50) Example.

Like the product described in the previous example, this product is used as a stored-value payment method for long distance. The difference being that it can be used with multiple merchants.

Redemption involves the required data, often just the PAN and an expiration date, to be entered into a interface. In some cases, the interface can be modified to make for a more pleasant user experience or to pre-populate certain variables, like address, that may not be required for the redemption of this product as opposed to credit. For example, a web services Provider 10 may require the address of the card holder to be entered so that address verification can be used to protect against credit card fraud. Use of a PAN may simplify and reduce the amount of data entry required from a Consumer 12. Given that the authentication mechanisms described above reduce the chance of fraud potential with these products, and that because of these mechanisms no card holder or address may be required, such additional fields may be confusing to the Consumer 12. The web site can be modified so that the Consumer 12 need not enter this information.

Step 7—Issuer Authorizes Payment.

During the redemption process, the Merchant (or Provider 10) interface will contact the Issuer 16 to authorize payment. This may be done using the many existing credit and debit authorization infrastructures. In one embodiment, the PAN “looks like” a credit or debit product from the Issuer 16. This allows the transactions to route from the Merchant to the Issuer 16 for authorization in a manner similar to how credit or debit payments are routed.

When the Issuer 16 receives the authorization for payment request, the PAN status and value is reviewed. Generally, the following key conditions should be met to receive an authorization from the Issuer 16: (1) PAN is flagged as active; (2) Merchant ID is recognized for authorization for the given PAN; and (3) value being authorized is within limit associated to the PAN, or in the stored-value account.

If these key conditions and potentially others are met then the transaction is authorized and an authorization is delivered back through the existing payments infrastructure, for example through MasterCard's Banknet, to an acquiring bank processor who then authorizes the transaction back to the merchant.

After payment has been authorized for the indicated amount, the transaction is completed with the Consumer 12.

Step 8—Settlement.

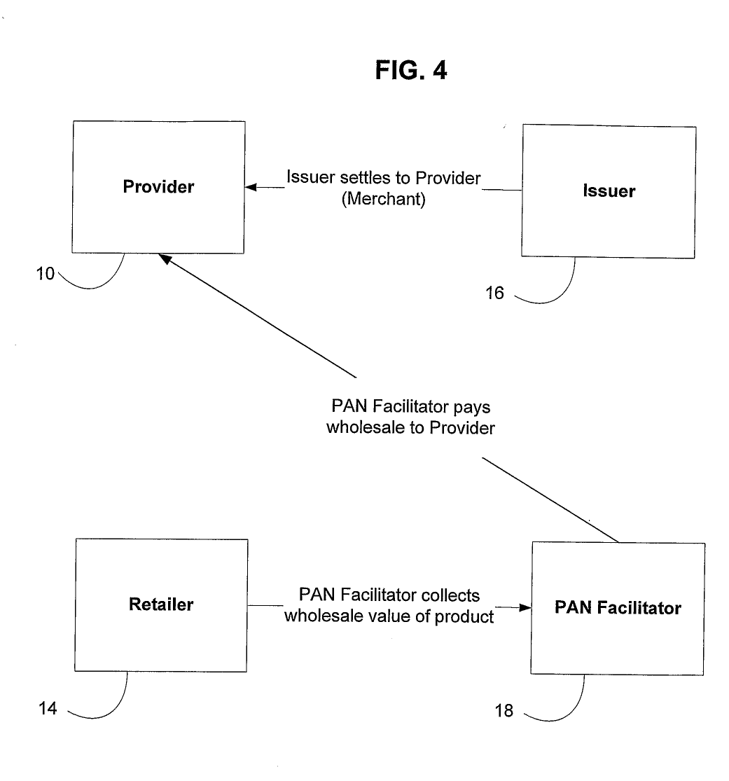

The present method may utilize the existing credit/debit card infrastructure in the U.S. which uses a two step system comprised of an authorization followed by a settlement. Settlement can occur in real-time or off-line (batch). Settlement is the step in which the money actually moves. The settlement steps are generally shown in FIG. 4.

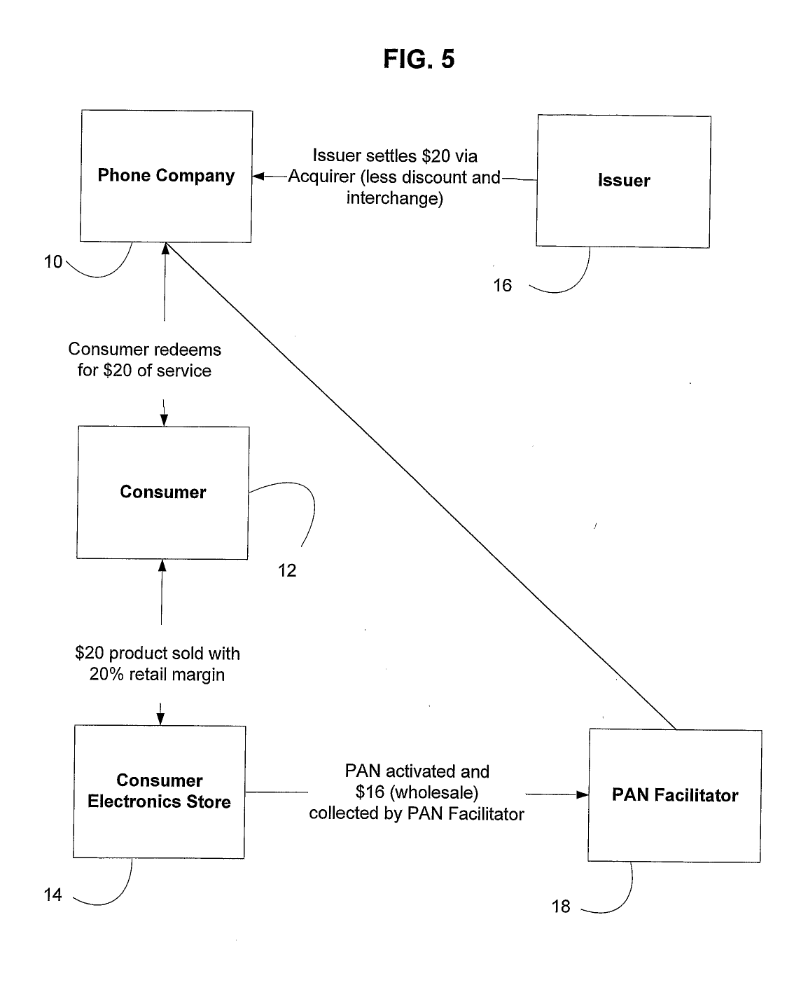

Following the example used throughout this disclosure as generally shown in FIG. 5, if an $20 wireless provider card product was redeemed, then the Provider 10, in this example the wireless provider expects that $20 dollars less any processing fees charged by the merchant bank (called the Discount fee and/or per item fee) will be deposited into their account. For this example, assume that the total processing fee is a 3% discount. This means that on a $20 product, the wireless phone service provider would receive $19.40 deposited in their bank account. A portion of the Discount fee includes an Interchange fee which is paid to the network (i.e. MasterCard) and to the Issuer 16. Although the Interchange fee is taken in account, to simplify the explanation of the remainder of the settlement steps, we assume that $20 was deposited into the Provider's account instead of $19.40.

In the present model, money is generally being transferred between the Issuer 16 and Retailer 14 only. A settlement needs to be performed so that the Provider 10 receives the Provider's share of the sale. It is desirable to have this settlement performed electronically and generally transparently. In the current example, to this point, the following transactions have taken place: (1) Consumer spends $20 in Retail (Retailer +$20); (2) Consumer redeems $20 worth of service with the Provider; (3) Provider received $20.00 from Issuer (Provider +$20.0); and (4) Issuer (−$20.00)

After settlement, the Retailer 14 should only have the difference between the retail price and the wholesale price so the Retailer 14 still has $20 which is $16 more than the Retailer 14 should have. The Issuer 16 is down $20.00. The Consumer is at par having spent $20 and redeemed $20.

The Provider 10 should receive $20 less the cost of distribution which includes the Retailer's margin. As stated earlier, the Retailer's margin in this example is 20%. Thus if it is assumed that no other charges are due to others participating in the distribution channel, then the Provider 10 would expect to receive the complete wholesale amount, $16.

To be able to make the necessary settlement transactions using existing processing and collections methods, the present method involves a step of having the Issuer 16 create a receivable from the Provider 10 for $20. One embodiment that can be used to implement this settlement step is by using a corporate account structure for multiple PANs. When a PAN is activated it is assigned to a Provider 10. The PAN is then listed as a “corporate card” using the Issuer's 16 business processes for servicing large corporate clients with multiple credit cards. At the end of the month, or some other preselected period, the Provider 10, which is treated similar to a corporate customer by the Issuer 16, will receive a card statement indicating all the PANs that have been assigned to the Provider 10 and the amount owed on each PAN.

For example, if a wireless phone service provider was the Provider 10 that has a relationship with an Issuer 16, the wireless phone service provider would have a single report delivered identifying all the cards on the account, although multiple reports may be used if AT&T Wireless so desired. All the PAN account numbers would be listed with all the amounts due on each credit card. The wireless phone service provider would be sent a corporate level statement indicating that $20 was due for account 6011998021027033. When the Provider 10 pays this amount, the Issuer 16 is back to par, but the Provider 10 is at zero.

The next steps resolve the final settlement issues. Multiple methods will be used to complete the settlement issues. These steps are generally referred to as “offsetting settlement.”

In one embodiment, the PAN Facilitator 18 collects $16 from the Retailer 14 and pays it to the Provider 10. This would make all parties whole. The Issuer 16 is at par as it has billed the Provider 10 for the $20 that it paid out. The Provider 10 has received $16 and the Retailer 14 kept $4.

In another embodiment, the Issuer 16 handles all the movement of money. One way this can occur is that for every redemption, the Issuer 16 collects the wholesale amount from the Retailer 14 and “net settles” via the corporate statement to the Provider 10.

An example item on the corporate bill to the Provider 10 might look like this:

| Account | Fee | Description |
|---|---|---|
| Item | −$20.00 | Offset the $20 paid to the |
| 6011998021027033 | | Provider during settlement |
| Redemption | | |
| Item | +$16.00 | Wholesale cost of Product |
| 6011998021027033 | | sold |
| Product Sale | | |

Given the Provider 10 was paid $20 during settlement, the accounting on this bill would leave the Provider 10 with $16.

In an embodiment in which the offsetting settlement is handled by the Issuer 16, the Issuer 16 will also bill the Retailer 14 for the $16 that needs to be collected. There are many ways that the Issuer 16 can do this. One example might be that the Issuer 16 provided the Retailer 14 with a separate revolving account to which all wholesale amounts due are billed. The Issuer 16 has access to risk management tools and processes wherein the Issuer 16 could decided if a Retailer 14 is credit worthy and also limit the amount of product that could be sold by any Retailer 14. The Retailer 14 may receive a quarterly, monthly, weekly, or daily bill from the Issuer 16 indicating the amount owed the Issuer 16. The PAN Facilitator 18 and the Issuer 16 any work together to incorporate tracking and auditing of wholesale calculations into the money flow model described herein.

Much of the existing credit/debit card processing infrastructure and servicing Providers 10 are capable of utilizing the present method. Redemption has takes place using standard credit/debit authorization and settlement systems. Money has been paid to the Provider 10 from the Issuer 16 may be returned to the Issuer 16 through corporate billing. The wholesale amount due the Provider 10 may be collected by either the Issuer 16 or the PAN Facilitator 18 and remitted to the Provider 10. Generally all the collections for these products in the market are handled by the Issuer 16 and the PAN Provider 10. The Issuer 16 model may also offer to guarantee payment to the Provider 10 thus relieving the Provider 10 of substantial collections processing and costs.

Although a variety of fee structures may be used to facilitate this method, the following example shows some of charges that may be incurred. The fees can show up in many ways in the supply chain. In some cases all the fees in the model may be presented to the Provider 10 so they can see all the cost in the model. This information could be delivered on Provider's corporate statement. For any given PAN, the statement might look like this:

| Account | Fee | Description |
|---|---|---|
| Item | −$20.00 | Offset the $20 paid to the |
| 6011998021027033 | | Provider during settlement |
| Redemption | | |
| Item | +$16.00 | Wholesale cost of Product sold |
| 6011998021027033 | | |
| Product Sale | | |
| Item | −$2.00 | Money kept in the supply chain |
| 6011998021027033 | | |
| Distribution Fee | | |
| Item | −$1.00 | Cost of this service |
| 6011998021027033 | | |
| Processing Fee | | |

A number of other parties may be used in connection with the present model including vendors to the Issuer 16, vendors to the PAN Facilitator 18, vendors (distributors) of the Provider's product and others. The actual data and money flow may need to be routed through such other parties.

Once a PAN has been redeemed it can be recycled for use again. To prevent fraud, a reused PAN may be assigned to a different Provider 10 or key elements such as the expiration date or other data may be changed.

The present system can be implemented on existing financial transactions systems and networks. Without limitation, these networks may include the Internet or other proprietary networks connecting financial entities of the type noted above. One or more of these steps may be performed using software code having one or more software modules that allow operation of the routines or subroutines needed. The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, SQL, C++, Java, COBOL, assembler, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived.

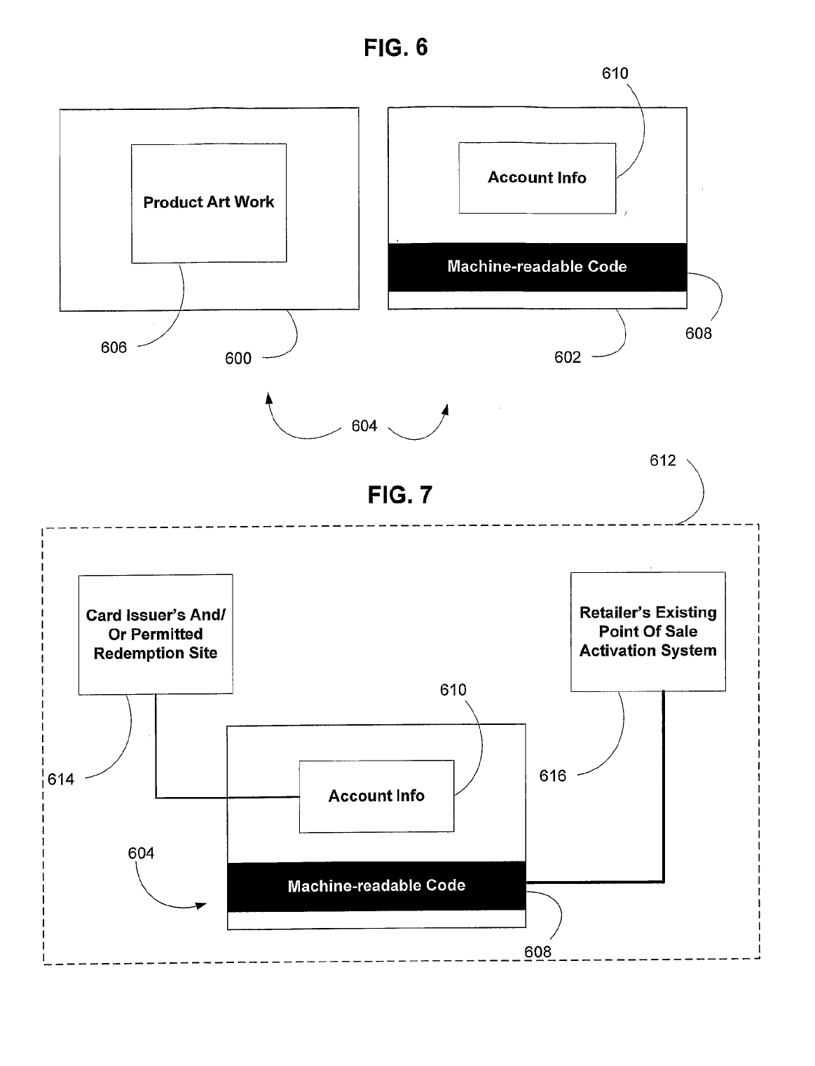

FIG. 6 shows the front side 600 and back side 602 of card 604 which can be distributed and activated in retail and used in the manner described below. Card 604 may include product art work 606 which may include artistic material, advertising material, materials identifying the retail store, material identifying a redemption site, associated value in dollars, points, or other measure, or other indicia relevant to the purpose, use or other characters of the card 604. Although “card,” including, by way of example, but not limitation, is used in this explanation, it should be understood that other printed materials or card receipt, slip, or sticker may be used as well. Further, the designation of one side or the other as back or front side in this disclosure is arbitrary and being used for clarity purposes and consistency of description only. The materials described as being on a particular side of the card can be reversed or all placed on one side of card 604.

Back side 602 includes machine-readable code 608. Machine-readable code or indicia 608 may in the form of letters, numbers, symbols, code arrangement, barcode, magnetic stripe, RFID chip, or any other code or indicia that may be read, sensed, or scanned by a machine. Further, by way of example, but not limitation, back side 602 may also include account information 610 that includes various information or indicia in human readable form including, for example, a PAN, expiration date, security code, CVV, or account information. This information will be used to redeem the value associated with the card 604. Machine-readable code 608 contains information that is at least partially different than account information 610. Specifically, the information contained in machine-readable code 608 is insufficient, or in a format or arrangement that is incompatible, to allow automatic swiping of card 604 to redeem the stored value using industry standard swipe type interfaces. This also applies to other industry standard reading for accounts such that the card is intentionally originated in a non-standardized format, compared to existing industry standard formats to prevent automatic thoughtless reading of the information. The industry non-standardized format is to be broadly interpreted to include formats and/or mismatching coding and/or reading of formats for performing the similar or equivalent purposes and/or functions that do no comply with industry standard credit card authorization infrastructure information formats.

This limitation prevents the card from being used in pre-authorization or partial authorization environments. Non-authorization or pre-authorization environments are those that permit the value or related account of card 604 to be credited prior to authorization from an Issuer 16. As discussed above, one example of a pre-authorization environment is a gas pump, which will allow, up to a selected maximum value, a Consumer 12 to pump gas without authorization from the Issuer 16 provided that the card meets industry standards. These standards may include, for example, proper size, the correct number of digits in the account number, passing a Luhn check, and as well as possibly the standard characteristics which would be expected on a “good” card.

The limitation of not including industry standard swipe technology in machine-readable code 608 is also useful in partial-authorization environments in which an authorization is provided by a proxy Issuer that acts as a middleman between the merchant and the Issuer 16. The proxy Issuer may authorize the transaction without actually checking for valid funds/credit from the Issuer 16. Although there may ultimately be protections for the Issuer 16 in this case, it may undesirable to allow such partial-authorizations. Thus, the limitation prevents redemption without a full authorization of account information 610, including, for example, the PAN. This allows the card issuer a level of control over how the card is redeemed beyond that normally found in the industry.

A Consumer 12 using card 604 is able to type in account information 610 into permitted redemption site interfaces. Permitted redemption sites may be different entities depending on the intended use of card 604. The card issuer may be, by way of example, but not limitation, a company conducting business over the Internet, or other electronic network. Such a card issuer may wish to distribute value cards, such as coupon cards, special offer cards, free give-aways, or free subscription cards to Consumers 12 in retail. Such a card issuer may partner with a Retailer 14 to distribute the cards in exchange for some consideration such a per-card payment, a distribution fee, offsetting cross-advertising, to name a few examples. The Consumer 12 receives the card at the Retailer's location in connection with some incentive program such as a free giveaway, making a minimum purchase at the Retailer 14, buying specific goods, or other marketing or sales programs. That card 604, after being activated, can be redeemed at the card issuer's web site for value, such as discounted purchases, free trials, or temporary subscriptions.

In another embodiment, the PAN associated with the card is associated with certain approved merchants as described in Section I above, so that the Consumer 12 can use the card at multiple locations. In its broadest use, card 604 may be usable at any location that allows a credit card number to be manually entered, including typing the relevant account information into a website interface, manually entering the number into a traditional swipe type credit card authorization device, or manipulating a interactive voice response system. This is made possible because the PAN system described above can be recognized using industry standard credit card authorization schemes.

Card 604 may include machine-readable information or code 608 that contains information to permit the Retailer 14 to activate the card 604 at the time the Consumer 12 is receiving it. This point of sale activation is useful to prevent shrinkage (described above). Machine-readable code 608 need not be associated with account information 610, but instead may be keyed to the Retailer's existing gift card redemption system or store card system so that the Retailer does not require any other or additional proprietary system to activate card 604. In this manner, a single card 604 can be used transparently by both the Retailer 14 for activation with the Retailer's existing system and by the card issuer using its existing credit card payment system or infrastructure. Further, value cannot be fraudulently decremented from the card using techniques that exploit any weaknesses of pre-authorization or partial authorization systems.

In accordance with the foregoing, a system for a method of using the present card 604 may be described as follows. A card issuer selects permitted redemption sites where it wishes to allow Consumers 12 to redeem value. Next, the card issuer partners with a retail site where the card issuer's cards 604 will be distributed. Cards 604 may arrive at the Retailer 14 in a deactivated state. Consumers 12 receive cards 604 from the Retailer 14, for example, in connection with a purchase, sales promotion or the like, and can redeem the value of card 604 at permitted redemption sites. Permitted redemption sites may include the card issuer's web site and/or other sites.

The present card may also be used in connection with a system 612 as shown in FIG. 7. System 612 includes card 604. The account information 610 on card 604 is associated with, and/or compatible with, loading or redeeming value from the card issuer 614 or the card issuer's permitted redemption sites. Machine-readable code 608 on card 604 is associated with, and/or compatible with, the Retailer's existing point of sale activation system 616.

The steps of a method of using system 612 are as follows. The card issuer provides at least one card 604 to a Retailer 14. Card 604 has printed thereon, or has integrated therewith, machine-readable code 608 and account information 610. The Retailer 14 provides card 604 to a Consumer 12. Card 604 is put into association with the point of sale activation system 616. This association may be swiping card 604 in a compatible reader, such as a bar code reader or a magnetic swipe reader, that reads machine-readable code 608. The identification information for card 604 is communicated to card issuer 614 to allow the card 604 to be redeemed at the card issuer's business or website and/or authorized redemption sites. It is understood that, as in the method described in Section I above, any number of service providers or other intermediaries may be involved with the authorization, clearance, and settlement of the transaction that involves activating, loading, or redeeming card 604. These intermediaries may include Issuers 16 and/or PAN Facilitators 18 as defined above.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

What is claimed is:

1. A method for managing at least one transaction through using credit card authorization payment infrastructures, the method comprising the steps of:
providing a personal account number, the personal account number corresponding to an account managed by an Issuer and being in a format different from industry stand credit card number format;
associating the personal account number with a predetermined value;
assigning the personal account number to a stored value instrument upon activation of the stored value instrument; and
providing the stored value instrument to a Consumer.

2. The method of claim 1, further comprising allowing the Consumer to make a purchase using the stored value instrument.

3. The method of claim 1, the step of providing a personal account number further comprising providing a plurality of personal account numbers to a PAN Facilitator.

4. The method of claim 3, the step of providing a personal account number further comprising the PAN Facilitator selectively providing the at least one personal account number of the plurality of personal account numbers to a Retailer for use with at least one stored value instrument distributed by the Retailer.

5. The method of claim 1, further comprising:
activating the stored value instrument at a point of sale; and
allowing the Consumer to make a purchase using the stored value instrument.

6. The method of claim 1, further comprising:
communicating the personal account number and a proposed transaction to the Issuer;
providing authorization from the Issuer for the proposed purchase; and
allowing the Consumer to make the proposed purchase using the stored value instrument.

7. The method of claim 6, further comprising performing a settlement between, the Issuer and a PAN Facilitator.

8. An apparatus for distribution in retail and redemption at selected redemption sites, the apparatus comprising:
a card, the card having a front side and back side;
machine readable information on at least one of the front side and back side, the machine readable information containing account data; and
account information indicia on at least one of the front side and back side, the account information indicia being at least partially different from the account data.

9. The apparatus of claim 8, further comprising the machine readable information being in a format that is different from industry standard credit card authorization infrastructure information format.

10. A method for using a card distributed in retail at least one redemption site, the method comprising the steps of:
providing a card, the card having a front side and back side, machine readable information on at least one of the front side and back side, the machine readable information containing account data, and account information indicia on at least one of the front side and back side, the account information indicia being at least partially different from the account data;
associating a value with the card; and
redeeming the value associated with the card in at least one redemption site.

11. The method of claim 10, further comprising the machine readable information being in a format that is different from industry credit card authorization infrastructure information format.

12. The method of claim 11, the step of providing the card further comprising providing the card having machine readable information that is compatible with a gift card redemption system of a selected Retailer and the step of redeeming the value further comprising redeeming the value by processing the card using the gift card redemption system.

13. The method of claim 11, further comprising associating the value with the card by assigning a personal account number with the card at point of sale, and associating a balance with the personal account number.

14. The method of claim 13, further comprising the step of redeeming the value being deducting a purchase amount from the balance.

15. The method claim 10, further comprising the redemption site being an online Retailer.

16. The method of claim 10, further comprising the redemption site being an authorized merchant.

17. The method of claim 10, further comprising associating the value with the card by assigning a personal account number, and assigning a redemption rule to the personal account number.

18. The method of claim 17, further comprising assigning the redemption rule being defining a group of merchants as authorized merchants and permitting redemption of the card value only at authorized merchants.

19. A system for distributing a card at retail that is redeemable at selected redemption sites, the system comprising:
a card, the card having a front side and back side, machine readable information on at least one of the front side and back side, the machine readable information containing account data, account information indicia on at least one of the front side and back side, the account information indicia being at least partially different from the account data, and a personal account number associated card;
a personal account number facilitation system, and
a redemption site interface, the redemption site interface being operative to connect to the personal account number facilitation system in response to using the card at a redemption site.

20. The system of claim 19, wherein the redemption site interface is a point of sale activation system.
